(19) United States
(12) Patent Application Publication
(10) Pub. No.: US 2021/0155238 A1
(43) Pub. Date: May 27, 2021

(54) 3D POSITION ESTIMATION SYSTEM FOR TRAILER COUPLER

(71) Applicant: Continental Automotive Systems, Inc., Auburn Hills, MI (US)

(72) Inventors: Xin Yu, Rochester Hills, MI (US); Matthew Donald Berkemeier, Beverly Hills, MI (US); Dhiren Verma Verma, Farmington Hills, MI (US)

(73) Assignee: Continental Automotive Systems, Inc., Auburn Hills, MI (US)

(21) Appl. No.: 16/695,799

(22) Filed: Nov. 26, 2019

(51) Int. Cl. B60W 30/18; G05D 1/02; B60W 50/00; G06T 7/73; G06T 7/20

(52) U.S. Cl. CPC B60W 30/18036; G05D 1/0231; B60D 1/36; G06T 7/73; G06T 7/20; B60W 50/00

(57) ABSTRACT

A system for locating a coupler of a trailer includes at least one camera positioned on a rear portion of a tow vehicle. A coupler detector module is constructed and arranged 1) to receive images of the coupler from the at least one camera and 2) to determining a two-dimensional (2D) pixel position of the coupler. A camera motion estimator module is constructed and arranged 1) to receive images from the at least one camera and data regarding motion of the tow vehicle and 2) determine a pose of the camera including a three-dimensional (3D) position and heading of the at least one camera. A coupler estimator module is constructed and arranged 1) to receive the pose of the camera and the 2D pixel position of the coupler and based thereon, 2) to determine an estimated 3D position of the coupler in real world coordinates.

### FIELD

This disclosure relates to an automotive vehicle, and more particularly to a 3D position estimation system for estimating a 3D position of a trailer hitch or coupler relative to a tow vehicle during trailer hitching.

### BACKGROUND

Reversing a tow vehicle with a connected trailer is a nontrivial and counter intuitive process which often frustrates drivers and poses challenges while attempting to maneuver trailers into tight spots. Drivers are often confused as to which way to turn the vehicle's steering wheel to get the desired change in direction of the trailer. The recent addition of Trailer Reverse Assist (TRA) type functions remedies this situation by allowing the driver/operator to steer the trailer directly with the vehicle while hacking. The conventional TRA systems use one or more cameras to locate the trailer hitch or coupler in 2D space and for maneuvering a vehicle in reverse to attachment to the trailer coupler. Such conventional systems are effective for avoiding collisions between the vehicle's tow ball and the trailer coupler but, since these systems only utilize 2D data, height of the coupler is not taken into consideration.

Thus, there is a need to provide a system and method to obtain a 3D estimation of a trailer coupler position so that the trailer coupler's height (Z) information can be used for tow vehicle height adjustment and the longitude and latitude (X, Y) trailer coupler position information can be used for collision avoidance between the trailer coupler and vehicle tow ball.

### SUMMARY

An objective of an embodiment is to fulfill the need referred to above. In accordance with the principles of an embodiment, this objective is obtained by providing a system for locating a coupler of a trailer. The system includes at least one camera positioned on a rear portion of a tow vehicle. A coupler detector module is constructed and arranged 1) to receive images of the coupler from the at least one camera and 2) to determining a two-dimensional (2D) pixel position of the coupler. A camera motion estimator module is constructed and arranged 1) to receive images from the at least one camera and data regarding motion of the tow vehicle and 2) determine a pose of the camera including a three-dimensional (3D) position and heading of the at least one camera. A coupler estimator module is constructed and arranged 1) to receive the pose of the camera and the 2D pixel position of the coupler and based thereon, 2) to determine an estimated 3D position of the coupler in real world coordinates.

In accordance with another aspect of an embodiment, a method is provided for locating a coupler of a trailer. The method receives, at a coupler detector module, images of the coupler from a camera positioned on a rear portion of a tow vehicle and in communication with the coupler detector module. The coupler detector module determines a two-dimensional (2D) pixel position of the coupler. A camera motion estimator module receives images from the camera in communication with the camera motion estimator module, and data regarding motion of the tow vehicle. The camera motion estimator module determines a pose of the camera including a three-dimensional (3D) position and heading of the camera. A coupler estimator module receives the pose of the camera and the 2D pixel position of the coupler; and based on the pose of the camera and the 2D pixel position of the coupler, the coupler estimator module determines an estimated 3D position of the coupler in real world coordinates.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a schematic side view of an exemplary tow vehicle connected with a trailer, with the vehicle having a 3D position estimation system in accordance with an embodiment of the invention.

FIG. 1A is a plan view of the tow vehicle of FIG. 1.

FIG. 2 is a schematic view of the exemplary tow vehicle of FIG. 1.

FIG. 3 is a flowchart of method steps of an embodiment.

FIG. 4 is a schematic view locating, via triangulation, a center of the coupler with camera pose at frame k and frame k+1 in accordance with and embodiment.

FIG. 5 is a schematic view of camera rays 1, n, and n+1 determining a 3D estimated location a trailer coupler in accordance with an embodiment.

FIG. 6 is schematic view of camera rays 1 and n determining an estimated location P′ of a trailer coupler in accordance with an embodiment.

FIG. 7 is schematic view of camera rays 1 and n+1 determining an estimated location P″ of the trailer coupler in accordance with an embodiment.

FIG. 8 shows calculations made in a Kalman filter of an embodiment.

FIG. 9 is schematic view of camera rays 1 and n+1 determining an estimated 3D location P of the trailer coupler after filtering with the Kalman filter of FIG. 8.

### DETAILED DESCRIPTION OF THE EXEMPLARY EMBODIMENTS

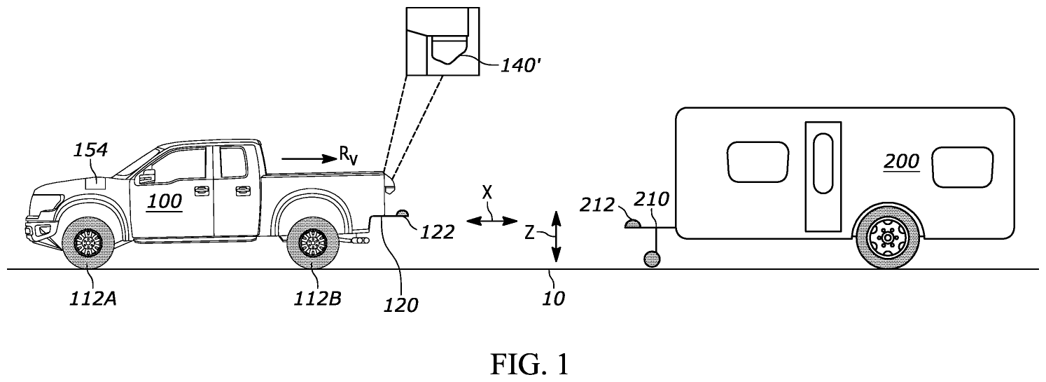

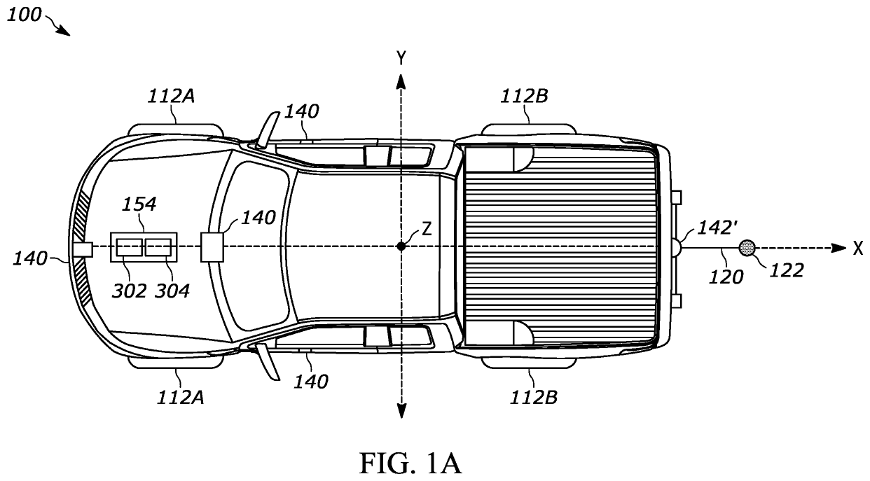

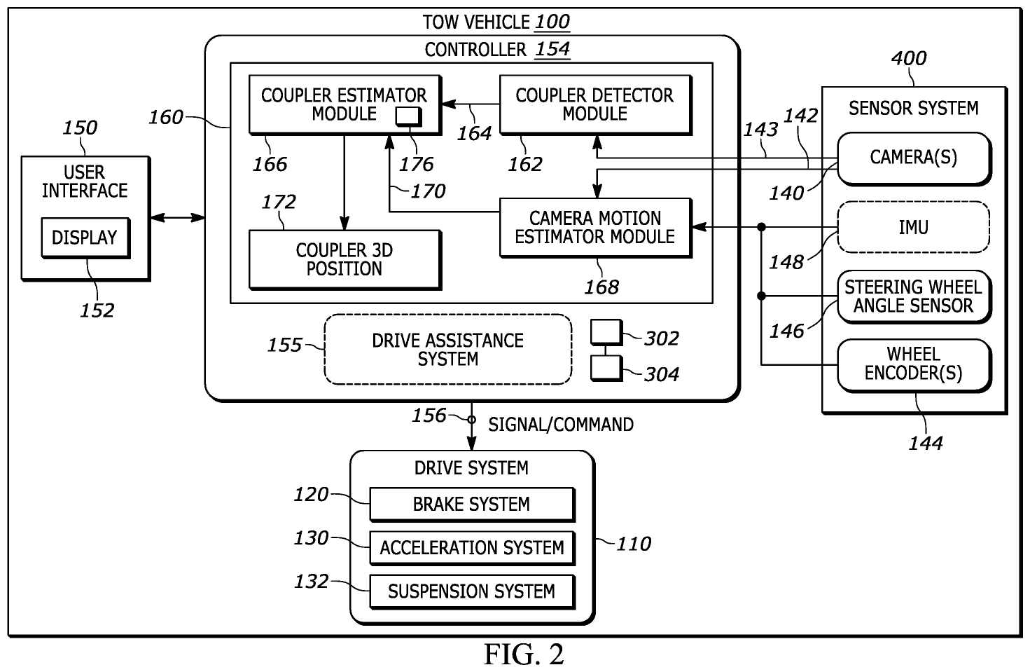

With reference to FIGS. 1, 1A and 2, a tow vehicle 100, such as, but not limited to a car, a crossover, a truck, a van, a sports-utility-vehicle (SUV), and a recreational vehicle (RV) may be configured to hitch and tow a trailer 200. The tow vehicle 100 is connected to the trailer 200 by way of a tow vehicle hitch 120 having a vehicle hitch ball 122 coupling to a trailer hitch 210 having a trailer coupler 212. It is desirable to have a tow vehicle 100 that is capable of autonomously backing up towards the trailer 200 identified from one or more representations of trailers displayed on a user interface 150, such as a user display 132. The user interface 150 receives one or more user commands from the driver via one or more input mechanisms or a touch screen display 152 and/or displays one or more notifications to the driver. The user interface 150 is in communication with a vehicle controller 154, which is in turn in communication with a sensor system 400 and a drive system 110. In some examples, the user interface 150 displays an image of an environment of the tow vehicle 100 (for example, the rear environment of the tow vehicle 100) leading to one or more commands being received by the user interface 150 (from the driver) that initiate execution of one or more behaviors.

In some implementations, the driver maneuvers the tow vehicle 100 towards the selected trailer 200, while in other examples, the tow vehicle 100 autonomously drives towards the selected trailer 200. The tow vehicle 100 includes the drive system 110 that maneuvers the tow vehicle 100 across a road surface 10 based on drive commands having X, Y, and Z components, for example. As shown, the drive system 110 includes a front wheels 112A and rear wheels 112B. The drive system 110 may include other wheel configurations as well. The drive system 110 may also include a brake system 120 that includes brakes associated with each wheel 112A, 112B, and an acceleration system 130 that is configured to adjust a speed and direction of the tow vehicle 100. In addition, the drive system 110 may include an adjustable suspension system 132 that includes tires associates with each wheel 112A, 112B, tire air, springs, shock absorbers, and linkages that connect the tow vehicle 100 to its wheels 112A, 112B and allows relative motion between the tow vehicle 100 and the wheels 112A, 112B. The suspension system 132 may be configured to adjust a height of the tow vehicle 100 allowing a tow vehicle hitch 120 (e.g., a vehicle hitch ball 122) to align with a trailer hitch 210 (e.g., trailer coupler 212), which allows for autonomous connection between the tow vehicle 100 and the trailer 200.

The tow vehicle 100 may include a sensor system 400 to provide reliable and robust driving. The sensor system 400 may include different types of sensors that may be used separately or with one another to create a perception of the environment of the tow vehicle 100. The sensor system 400 aids the driver in make intelligent decisions based on objects and obstacles detected by the sensor system 400 or aids the drive system 110 in autonomously maneuvering the tow vehicle 100. The sensor system 400 may include one or more cameras 140 supported by the tow vehicle 100 to capture images 142, 143 of the environment of the tow vehicle 100. In an embodiment, at least one camera 140′ is a rear camera that is mounted on a rear portion of the tow vehicle 100 to provide a view of a rear driving path for the tow vehicle 100. In addition, the rear camera 140′ is positioned such that it captures a view of the tow vehicle hitch ball 122. In some examples, the rear camera is a monocular camera that produces a two-dimensional image. Other camera types may also be used.

The sensor system 400 also includes at least one of the following sensors: wheel encoders 144, acceleration and a steering wheel angle sensors 146, and an optional Inertial Measurement unit (IMU) 148 to determine a position of the coupler 212 in pixel coordinates within an image 143 as well as the coupler position in the three-dimensions (3D) world, as will be explained more fully below. The optional IMU 148 is configured to measure a linear acceleration of the tow vehicle 100 (using one or more accelerometers) and a rotational rate of the tow vehicle 100 (using one or more gyroscopes). In some examples, the IMU 148 also determines a heading reference of the tow vehicle 100. Therefore, the IMU 148 determines the pitch, roll, and yaw of the tow vehicle 100. The sensor system 400 may include other sensors such as, but not limited to, radar, sonar, LIDAR (Light Detection and Ranging, which can entail optical remote sensing that measures properties of scattered light to find range and/or other information of a distant target), LADAR (Laser Detection and Ranging), etc.

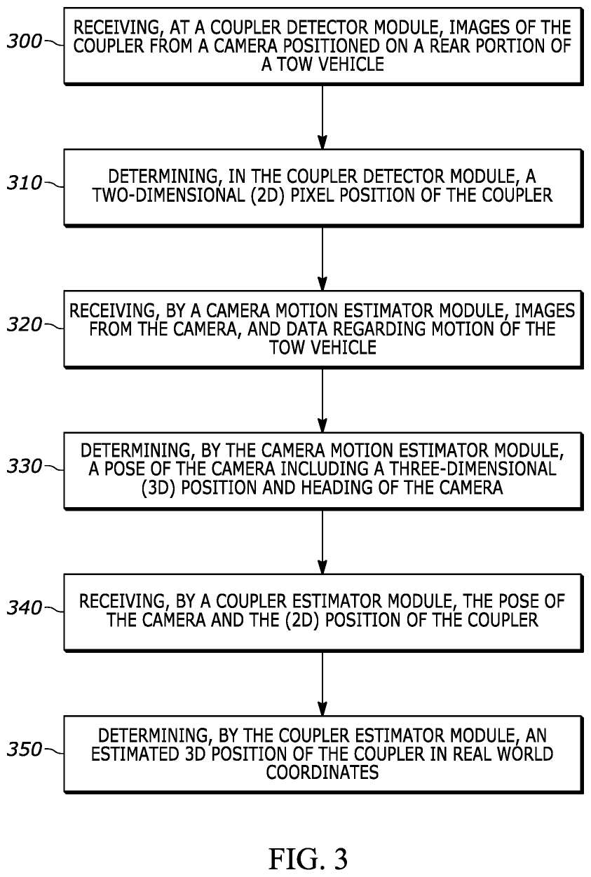

Referring to FIGS. 2 and 3, and in accordance with an embodiment, a vehicle controller 154 includes a coupler 3D position estimation system 160 that is constructed and arranged to estimate the 3D or world position of the coupler 212 associated with the trailer 200 in real time. The 3D position estimation system 160 includes a coupler detector module 162 that in step 300 of FIG. 3, receives images 143 from the rear camera 140′ and an optional input from the user. The coupler detector module 162, in step 310, determines the 2D pixel position (e.g., longitude X, and latitude Y) of the coupler 212 on the image and sends this 2D position signal 164 to a coupler estimator module 166. The monocular rear camera 140′ cannot provide distance information without motion, therefore the embodiment incorporates vehicle motion to estimate the motion of the rear camera 140′. Thus, the 3D position estimation system 160 includes a camera motion estimator module 168, which, in step 320, receives images 142 from the camera 140′ and signal from the steering wheel angle sensor, 146, wheel encoders (e.g. wheel ticks) and optionally from the IMU 148. The camera motion estimator module 168, in step 330, determines the pose of rear camera 140′ (longitude X, latitude Y, height, Z and heading) and sends a pose data signal 170 to the coupler estimator module 166. Based on signals 164 and 170 received (step 340), the coupler estimator module 166, in step 350, determines a 3D position 172 (longitude X, latitude Y, and height Z) of the trailer coupler 212 in real world coordinates.

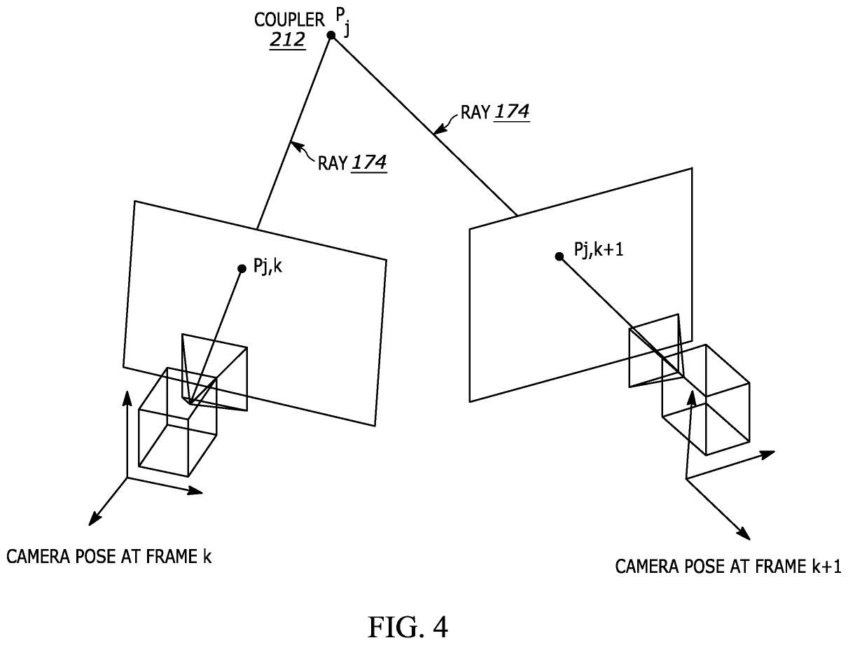

With reference to FIG. 4, the estimation of the 3D position 172 of the coupler 212 is from two rays 174 using Triangulation in the coupler estimator module 166 using the following steps:

1: Adopt coupler detector module 162 to detect/track the coupler 12 in each image 143. Record the coupler center (Pj,k).

2: Obtain camera pose (longitude X, latitude Y, height, Z and heading) from the camera motion estimator module 168.

3: Obtain the rays 174 connecting camera origin and coupler's 2D position (Pj,k) on the image frame.

4: Use Least Square approach to find the intersection (Pj) of the two rays 174 in 3D coordinate system.

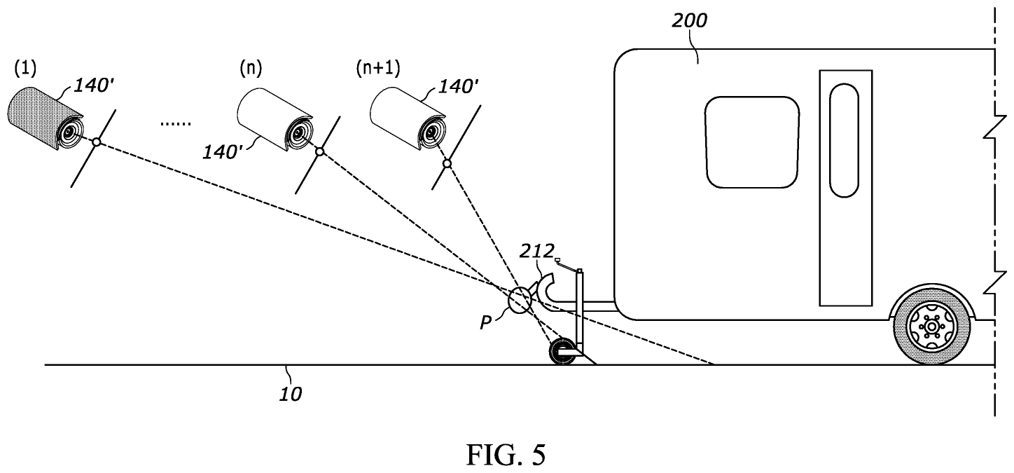

With reference to FIG. 5, at various time intervals, by forward projecting the 2D points in an image coordinate to 3D points in a world coordinate, the rays 174 should intersect at the coupler position P. For each pair of the initial ray (1) and new ray pair (n), the embodiment employs the known Triangulation approach to find the intersection position. However, due to noise, it is difficult for the rays 174 to intersect at a perfect position in a real application.

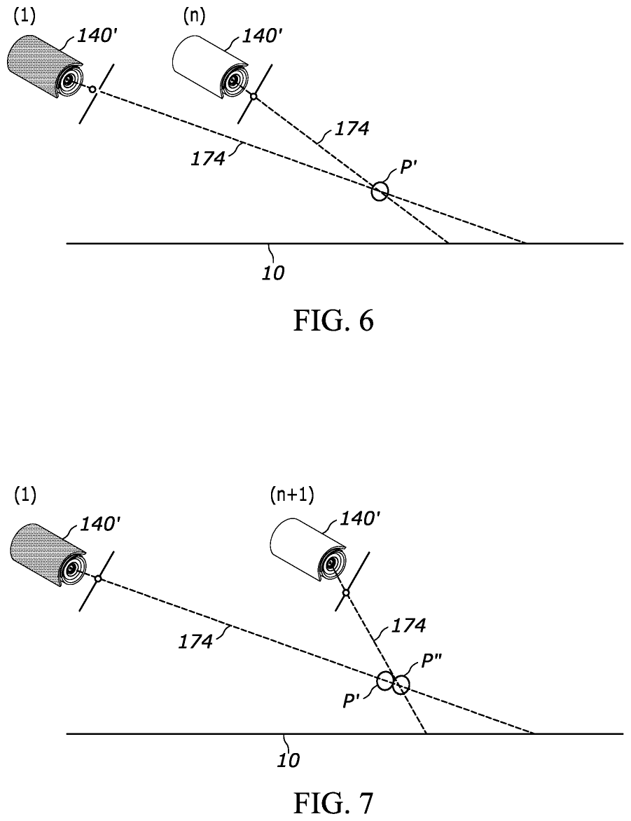

With reference to FIGS. 6-7, due to the noise, each pair of rays 174 may define a different estimation of the coupler position P′, P″ (e.g., estimated coupler position P″ from the pair of rays (1) and (n+1) of FIG. 7 deviates from the estimated coupler position P′ from the pair of (1) and (n) rays of FIG. 6).

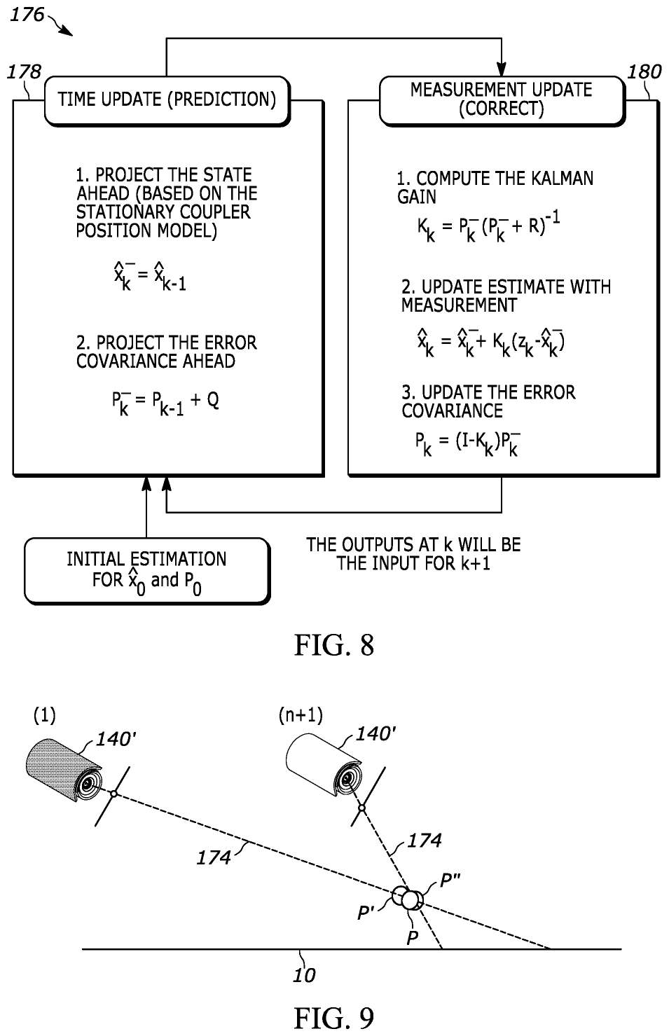

Thus, with reference to FIG. 2, the coupler estimator module 166 includes a Kalman filter 176 to filter out noise and to converge to the true estimated coupler position P in real time. As shown in FIG. 8, the state of Kalman filter 176 is the 3D coupler position P relative to the coordinate's origin: \hat{x}:k=(longitudinal, lateral, height). The Kalman filter 176 executes a time update calculation 178 and a measurement update calculation 180. The covariance Pₖ describes the uncertainty of the coupler position estimation. The measurement zₖ is the coupler estimation from the new pair of rays 174 using Triangulation. Each pair of rays 174 is composed of the initial ray 1 and the new ray (n+1). The estimated coupler position will converge to the true estimated value P once the uncertainty Pₖ converges.

With the estimated coupler 3D position P of the coupler known, in some implementations, the controller 154 sends the determined coupler longitudinal distance X, the lateral distance Y, and the vertical distance or coupler height Z to the user interface 150, for example, the display 152, to be displayed to the driver. The longitudinal distance X, the lateral distance Y, and the coupler height Z are considered by the driver while backing up the tow vehicle 100 towards the trailer 200 or by a drive assistance system 155 while the tow vehicle 100 is autonomously maneuvering towards the trailer 200. In some examples, the controller 154 includes the drive assistance system 155 that receives the coupler 212 longitudinal distance X, the lateral distance Y, and the vertical distance and/or the coupler height Z and based on the received information determines a path between the tow vehicle 100 and the trailer 200 leading the tow vehicle 100 to align with the trailer 200 for hitching. In addition, the drive assistance system 155 sends the drive system 110 one or more commands 156 causing the drive system 110 to autonomously maneuver the tow vehicle 100 in a rearwards direction RV towards the trailer 200.

Thus, the system advantageously provides a 3D position estimation of a trailer coupler so that the trailer coupler's height (Z) information can be used for tow vehicle height adjustment and the longitude and latitude (X, Y) trailer coupler position information can be used for collision avoidance between the trailer coupler and vehicle tow ball. Furthermore, since the system tracks only one point on the coupler, it requires minimal computational resources and thus can run on less costly hardware.

The vehicle controller 154 includes a computing device (or processor circuit) 302 (e.g., central processing unit having one or more computing processors) in communication with non-transitory memory 304 (e.g., a hard disk, flash memory, random-access memory) capable of storing instructions executable on the computing processor(s) 302. The processor circuit 302 can be used by any of the modules 162, 166, 168, or each module can include its own processor circuit.

Various implementations of the systems and techniques described here (e.g., processor circuit 302, module processor circuits, etc.) can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A method of locating a coupler of a trailer, the method comprising:
receiving, at a coupler detector module, images of the coupler from a camera positioned on a rear portion of a tow vehicle and in communication with the coupler detector module;
determining, in the coupler detector module, a two-dimensional (2D) pixel position of the coupler;
receiving, by a camera motion estimator module, images from the camera in communication with the camera motion estimator module, and data regarding motion of the tow vehicle;
determining, by the camera motion estimator module, a pose of the camera including a three-dimensional (3D) position and heading of the camera;
receiving, by a coupler estimator module, the pose of the camera and the 2D pixel position of the coupler; and
based on the pose of the camera and the 2D pixel position of the coupler, determining, by the coupler estimator module, an estimated 3D position of the coupler in real world coordinates.

2. The method of claim 1, wherein the estimated 3D position of the coupler in real world coordinates includes a longitude position, a latitude position, and a height position of the coupler.

3. The method of claim 1, further comprising:
sending, to a drive system of the tow vehicle, instructions causing the tow vehicle to autonomously drive along a path in a rearward direction towards the 3D position of the coupler.

4. The method of claim 1, wherein each of the determining steps is executed by a processor circuit associated with the respective module.

5. The method of claim 1, wherein the step of determining a 3D position of the coupler in real world coordinates comprises:
at various time intervals, forward projecting 2D points in image coordinates of a pair of rays of the camera, to 3D points in real world coordinates, with the intersection of each pair of rays defining the estimated 3D position of the coupler.

6. The method of claim 5, further comprising:
when noise is present causing the estimated 3D position of the coupler of one pair of rays of the camera to deviate from the estimated 3D position of the coupler of another pair of rays, filtering out the noise so as to obtain a converged, single estimated 3D position of the coupler.

7. The method of claim 6, wherein obtaining the converged, single estimated 3D position of the coupler includes using triangulation.

8. The method of claim 6, wherein the step of filtering includes using a Kalman filter.

9. The method of claim 1, wherein the step of receiving data regarding motion of the tow vehicle includes receiving at least acceleration and steering wheel angle data, and wheel encoder data.

10. A system for locating a coupler of a trailer, the system comprising:
at least one camera positioned on a rear portion of a tow vehicle,
a coupler detector module constructed and arranged 1) to receive images of the coupler from the at least one camera and 2) to determining a two-dimensional (2D) pixel position of the coupler;
a camera motion estimator module, constructed and arranged 1) to receive images from the at least one camera and data regarding motion of the tow vehicle and 2) determine a pose of the camera including a three-dimensional (3D) position and heading of the at least one camera; and
a coupler estimator module constructed and arranged 1) to receive the pose of the camera and the 2D pixel position of the coupler and based thereon, 2) to determine an estimated 3D position of the coupler in real world coordinates.

11. The system of claim 10, wherein coupler estimator module is constructed and arranged to determine the estimated 3D position of the coupler in real world coordinates as a longitude position, a latitude position, and a height position of the coupler.

12. The system of claim 10, further comprising the tow vehicle and a drive system for the tow vehicle, the drive system being constructed and arranged to cause the tow vehicle to autonomously drive along a path in a rearward direction towards the 3D position of the coupler.

13. The system of claim 10, wherein each of the coupler detector module, the camera motion estimator module, and the coupler estimator module is associated with a processor circuit.

14. The system of claim 10, wherein the coupler estimator module is constructed and arranged, at various time intervals, to forward project 2D points in image coordinates of a pair of rays of the camera, to 3D points in real world coordinates, with the intersection of each pair of rays defining the estimated 3D position of the coupler.

15. The system of claim 14, further comprising a filter constructed and arranged when noise is present causing the estimated 3D position of the coupler of one pair of rays of the camera to deviate from the estimated 3D position of the coupler of another pair of rays, to filter out the noise so as to obtain a converged, single estimated 3D position of the coupler.

16. The system of claim 15, wherein the filter is a Kalman filter.

17. The system of claim 10, further comprising an acceleration and steering wheel angle sensor, and wheel encoder sensor, each associated with the camera motion estimator module to provide the data regarding motion of the tow vehicle.
